(19) United States
(12) Patent Application Publication
(10) Pub. No.: US 2024/0367993 A1
(43) Pub. Date: Nov. 7, 2024

(54) HIGH-ENTROPY RARE EARTH ZIRCONATE AND METHOD FOR MANUFACTURING SAME

(71) Applicant: IUCF-HYU (Industry-University Cooperation Foundation Hanyang University), Seoul (KR)

(72) Inventors: Tae Seup SONG, Seoul (KR); Myeung Woo RYU, Seoul (KR)

(21) Appl. No.: 18/776,202

(22) Filed: Jul. 17, 2024

Related U.S. Application Data
(63) Continuation of application No. PCT/KR2023/007124, filed on May 25, 2023.

(30) Foreign Application Priority Data
Nov. 29, 2022 (KR) 10-2022-0162870

(51) Int. Cl. C01G 25/00

(52) U.S. Cl. CPC C01G 25/006; C01P 2002/36; C01P 2002/50; C01P 2002/72; C01P 2002/77; C01P 2002/82; C01P 2002/85; C01P 2004/03; C01P 2004/04; C01P 2006/32

(57) ABSTRACT

The present invention relates to high-entropy rare earth zirconates. The high-entropy rare earth zirconate structure of the present invention has a single phase, and, compared to the conventional rare earth zirconate, lattice distortion increases and oxygen vacancies are increased to suppress heat transfer, so it can be confirmed that it has an excellent heat barrier effect as a heat shield coating material. It can maintain a stable single phase without phase change even in a high temperature environment of 1000°° C. or higher.

### TECHNICAL FIELD

The present invention relates to heat shielding materials, and more specifically to high-entropy heat shielding materials.

### BACKGROUND ART

The heat shield coating system is applied to high-temperature parts such as aircraft and gas turbine engines and is a ceramic coating system that extends the limits of turbine parts and allows them to operate at higher temperatures.

Yttria-stabilized zirconia (YSZ), the most common material for heat shield coating layers, is used as a representative topcoat material due to its excellent properties such as high melting point, low thermal conductivity, similar thermal expansion coefficient with metal bond coating, and excellent thermal and mechanical properties. However, YSZ's thermal durability and heat shielding performance deteriorate due to limitations in sintering density and phase change above 1200° C., limiting its use. In addition, it has relatively high heat conduction compared to materials developed recently, so there is a problem in that heat conversion efficiency is low when driven under high operating temperature conditions.

YSZ material has a thermal conductivity of about 3 W/mK at room temperature, and above 1200° C., the metastable tetragonal phase (t′-phase) separates into the stable tetragonal phase (t-phase) and cubic phase, and when cooled, the tetragonal phase transitions to a monoclinic phase, and the resulting volume change can cause problems such as cracks in the heat shield coating layer.

### DISCLOSURE

### Technical Challenges

The present invention is to provide a heat shielding material that maintains a stable single phase at high temperatures.

The technical challenges of the present invention are not limited to the above, and other technical challenges not mentioned will be clearly understood by those skilled in the art from the description below.

### Technical Solution

One aspect of the present invention may provide a high-entropy rare earth zirconate represented by the following Formula 1.

A₂Zr₂O₇ (1)

In Formula 1, A may include at least four types of trivalent cations and at least one type of divalent cation.

There may be 5 to 20 different ions included in the A site. Ions included in the A site may have the same stoichiometric ratio (equimolar ratio). The difference in ionic radii of the ions included in the A site may be 1 to 20%.

The trivalent cation may be selected from transition metal ions or lanthanide ions, and the divalent cation may be selected from alkaline earth metal ions. The trivalent cation may be at least four types selected from Y³⁺, La³⁺, Nd³⁺, Sm³⁺, Gd³⁺, Ho³⁺, Er³⁺, Yb³⁺, and combinations thereof. The divalent cation may be at least one selected from Be²⁺, Mg²⁺, Ca²⁺, Sr²⁺, Ba²⁺, Ra²⁺, and combinations thereof.

A structure of the high-entropy rare earth zirconate may be a defective fluorite structure or a pyrochlore structure. The high-entropy rare earth zirconate may maintain a single phase in a high temperature environment ranging from room temperature to 1200° C.

### Advantageous Effects

According to the present invention described above, the structure of the high-entropy rare earth zirconate of the present invention has increased lattice distortion and oxygen vacancies compared to the conventional rare earth zirconate, thereby suppressing heat transfer. Therefore, as a heat shield coating material, it can exhibit an excellent heat barrier effect and can maintain a stable single phase without phase change even in a high temperature environment of 1000° C. or higher.

However, the effects of the present invention are not limited to the effects mentioned above, and other effects not mentioned will be clearly understood by those skilled in the art from the description below.

### DESCRIPTION OF DRAWINGS

FIGS. 1A and 1B are schematic diagrams showing conventional rare earth zirconates and high-entropy rare earth zirconates according to embodiments of the present invention in relation to the defective fluorite structure and pyrochlore structure.

FIGS. 2A, 2B, 2C, and 2D show scanning electron microscopy (SEM) and energy dispersive spectroscopy (EDS) results (FIG. 2A), X-ray photoelectron spectroscopy (XPS) results (FIG. 2B), Raman spectroscopy results (FIG. 2C), and transmission electron microscopy (TEM) results (FIG. 2D) for conventional rare earth zirconates of Yb₂Zr₂O₇ and Nd₂Zr₂O₇ and high-entropy rare earth zirconates of HEDF (high-entropy defective fluorite) and HEP (high-entropy pyrochlore) according to an embodiment of the present invention.

FIGS. 3A, 3B, 3C, and 3D are X-ray photoelectron spectroscopy (XPS) results of conventional rare earth zirconates and high-entropy rare earth zirconate according to an embodiment of the present invention.

FIG. 4 is a graph showing the calculation results of the phonon mean free path of high-entropy rare earth zirconates according to an embodiment of the present invention compared to conventional rare earth zirconates.

FIGS. 5A, 5B, and 5C are graphs showing specific heat capacity (FIG. 5A), thermal diffusivity (FIG. 5B), and thermal conductivity (FIG. 5C) of high-entropy rare earth zirconates according to embodiments of the present invention compared to conventional rare earth zirconates.

### MODES OF THE INVENTION

Since the present invention can be subject to various changes and have various forms, specific embodiments will be illustrated in the drawings and described in detail in the text. However, this is not intended to limit the present invention to a specific disclosed form, and should be understood to include all changes, equivalents, and substitutes included in the spirit and technical scope of the present invention. While describing each drawing, similar reference numerals are used for similar components.

Unless otherwise defined, all terms used herein, including technical or scientific terms, have the same meaning as commonly understood by a person of ordinary skill in the technical field to which the present invention pertains. Terms defined in commonly used dictionaries should be interpreted as having a meaning consistent with the meaning in the context of the related technology, and should not be interpreted in an ideal or excessively formal sense unless explicitly defined in the present application.

Throughout the specification of the present application, when a part “includes” a certain element, this means that it may further include other elements rather than excluding other elements, unless specifically stated to the contrary.

The terms “about”, “substantially”, etc. used throughout the specification herein are used to mean at or close to that value when a tolerance is given to the stated meaning, and are used to prevent an unscrupulous infringer from unfairly using the disclosure containing precise or absolute figures used to aid understanding of the subject matter.

High-Entropy A₂Zr₂O₇ Heat Shield Material

One embodiment of the present invention can provide high-entropy rare earth zirconate. The high-entropy rare earth zirconate may be represented by the following Formula 1.

A₂Zr₂O₇ (1)

In Formula 1, A may include at least four types of trivalent cations and at least one type of divalent cation. The trivalent cation may be selected from transition metal ions or lanthanide ions, and specifically, may be at least four types selected from Y³⁺, La³⁺, Nd³⁺, Sm³⁺, Gd³⁺, Ho³⁺, Er³⁺, Yb³⁺, and combinations thereof. The divalent cation may be selected from alkaline earth metal ions, and specifically, may be at least one selected from Be²⁺, Mg²⁺, Ca²⁺, Sr²⁺, Ba²⁺, Ra²⁺, and combinations thereof.

There may be 5 to 20 different ions included in the A site.

In addition, the ions included in the A site may have the same stoichiometric ratio, that is, may be contained in equimolar amounts. For example, if there are 5 types of ions included in the A site, 4 types of trivalent cations and 1 type of divalent cation may be included, and in this case, the high-entropy rare earth zirconate of the present invention may be expressed as (A¹ₐ₁A²ₐ₂A³ₐ₃A⁴ₐ₄A⁵ₐ₅)₂Zr₂O₇. Here, four of A¹, A², A³, A⁴ and A⁵ may be different types of trivalent cations, one of which may be a divalent cation, a1+a2+a3+a4+a5=1, an>0, and n is 1 to 5.

The structure of the high-entropy rare earth zirconate of Formula 1 may be a defective fluorite structure or a pyrochlore structure.

In one embodiment, Formula 1 may be (La_{0.2}Nd_{0.2}Sm_{0.2}Gd_{0.2}Ca_{0.2})₂Zr₂O₇ with a pyrochlore structure, or (Y_{0.2}Ho_{0.2}Er_{0.2}Yb_{0.2}Mg_{0.2})₂Zr₂O₇ with a defective fluorite structure.

The ionic radius ratio (r_{A}/r_{Zr}), which is the ratio of the average radius of the ions included in the A site to the radius of the Zr ion, may be less than 2. Here, r_{A} may be the average radius of the ions in the A site, and r_{Zr} may be the radius of the Zr ion. Specifically, in the case of a Pyrochlore structure, the ionic radius ratio (r_{A}/r_{Zr}) of the ions included in the A site may be 1.46 to 1.78, specifically 1.49 to 1.7, and more specifically 1.5 to 1.6, and, in one specific example, may be 1.51 to 1.56. In addition, in the case of a defective fluorite structure, the ionic radius ratio (r_{A}/r_{Zr}) of the ions included in the A site may be 1 to 1.46, specifically 1.2 to 1.43, more specifically 1.28 to 1.4, and, in one specific example, may be 1.32 to 1.38.

The structure of the high-entropy rare earth zirconate of the present invention can maintain its original single phase without phase transition even in a high temperature environment ranging from room temperature to 1200° C., specifically room temperature to 1000° C.

Additionally, the ions included in the A site may have an ionic radius difference (%) of 1 to 20%. Here, the ionic radius difference (%) may be a percentage obtained by dividing the difference between the maximum and minimum ionic radii among the ionic radii of the ions included in the A site by the average ionic radius of the ions included in the A site. Specifically, the ionic radius difference (%) may be 3 to 18%, and more specifically, 8 to 15%. Therefore, because the ions included in the A site have similar radii, the high-entropy rare earth zirconate of the present invention can maintain the structural stability despite cation substitution. In detail, examples of ions included in the A site and differences in ionic radii can be found in Table 1 below.

TABLE 1

| Defective fluorite structure | | | | Pyrochlore structure | | | |
|---|---|---|---|---|---|---|---|
| | ionic radius (r) | | | | ionic radius (r) | | |
| cation | (angstrom) | | | cation | (angstrom) | | |
| Zr⁴⁺ | 0.72 | | r_{A}/r_{Zr} = | Zr⁴⁺ | 0.72 | | r_{A}/r_{Zr} = |
| Y³⁺ | 1.019 | average | 1.3647 | La³⁺ | 1.16 | average | 1.5336 |
| Ho³⁺ | 1.015 | ionic | | Nd³⁺ | 1.109 | ionic | |
| Er³⁺ | 1.004 | radius = | | Sm³⁺ | 1.079 | radius = | |
| Yb³⁺ | 0.985 | 0.9826 | | Gd³⁺ | 1.053 | 1.1042 | |
| Mg²⁺ | 0.89 | (ionic radius | | Ca²⁺ | 1.12 | (ionic radius | |
| | | difference = | | | | difference = | |
| | | 13.51%) | | | | 9.67%) | |

Preparation Example: Preparation Method of High-Entropy Rare Earth Zirconate A₂Zr₂O₇

To prepare the high-entropy heat shielding material of the present invention, the oxide powder of the above-mentioned metal cation (corresponding to A in Chemical Formula 1 above and Zr) was used. First, to remove moisture from the desired type of metal oxide powder, it was dried in an oven at 150° C. for 20 hours. Afterwards, the weight was measured according to the stoichiometric ratio of each metal element, and the metal oxide powder was mixed by wet ball-milling at 240 rpm for 24 hours using zirconia balls of various diameters and ethanol. Next, homogeneous powder was secured using a 325-mesh sieve, and then metal oxide pellets were manufactured using a mold. The metal oxide pellets were subjected to cold isostatic pressing (CIP) at 300 MPa for 3 minutes and then sintered at high temperature to produce high-entropy rare earth zirconate. For the pyrochlore structure, it was sintered at 1600° C. for 30 hours, and for the defective fluorite structure, it was sintered at 1500° C. for 30 hours.

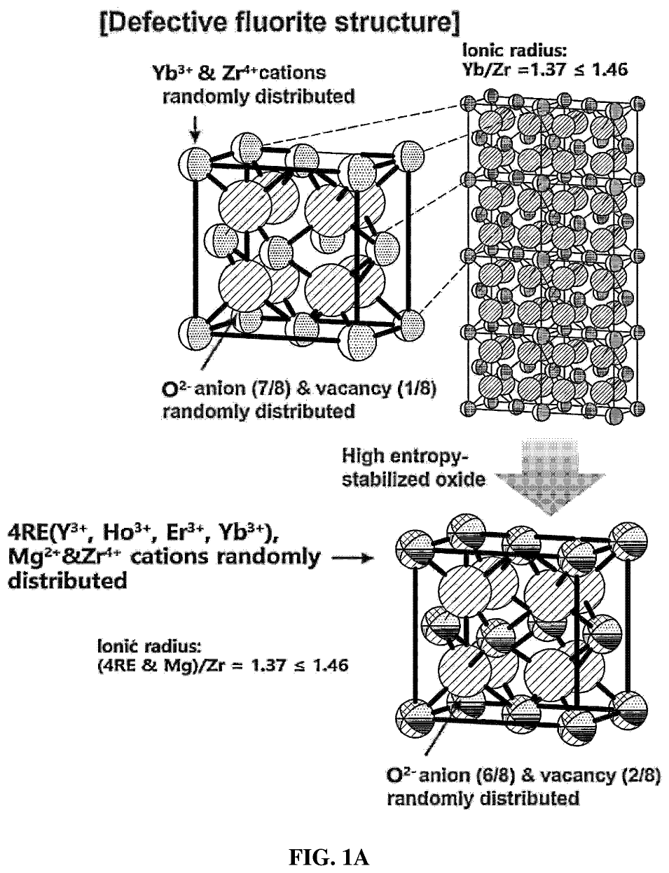

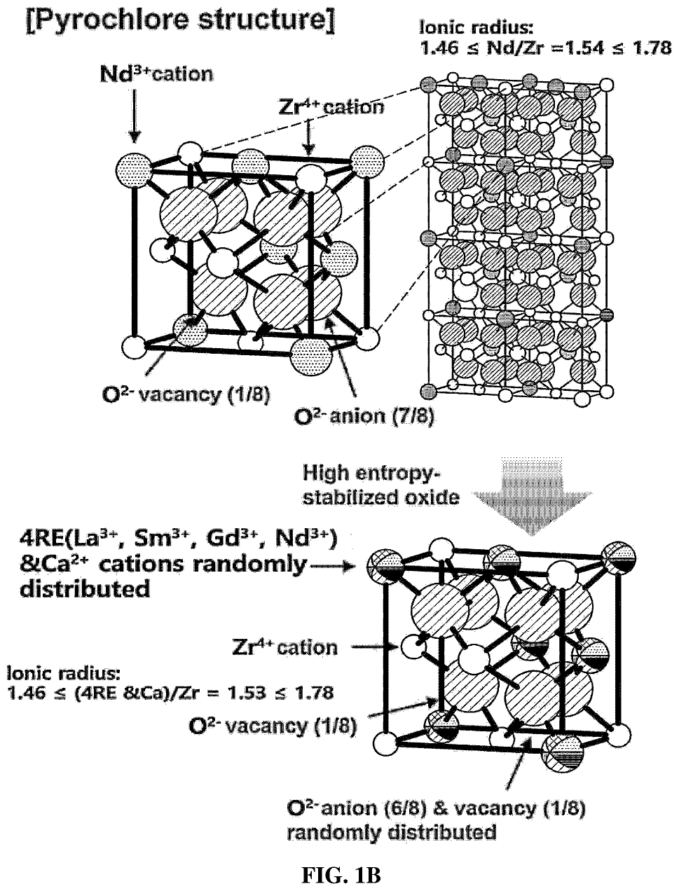

FIGS. 1A and 1B are schematic diagrams showing conventional rare earth zirconates and high-entropy rare earth zirconates according to embodiments of the present invention in relation to the defective fluorite structure and pyrochlore structure.

Referring to FIGS. 1A and 1B, conventional rare earth zirconates can be divided into a defective fluorite structure and a pyrochlore structure according to the difference in ionic radii between cations and oxygen ions. The above two structures each contain 7 oxygen ions and 1 oxygen vacancy site within the unit structure, and exhibit low heat conduction properties due to these structural features, so they are used as heat shield coating materials. However, in yttria-stabilized zirconia (YSZ), the metastable tetragonal phase (t′-phase) separates into the stable t-phase and cubic phase in a high temperature environment of 1200° C. or higher, and the tetragonal phase may transition to a monoclinic phase when cooled, and the resulting volume change may cause cracks in the heat shield coating layer.

Meanwhile, the high-entropy rare earth zirconate of the present invention was produced by including five or more types of cations having the same stoichiometric ratio (equimolar) at the A site. Specifically, the cation at the A site may include at least four types of rare earth cation ions and at least one type of alkaline earth metal cation ion. The conventional rare earth zirconate structure described above has one oxygen vacancy, but the high-entropy rare earth zirconate of the present invention, which has been modified by including the divalent cation in the A site, has six oxygen ions and two oxygen vacancies in the unit structure. It may have a structure with increased oxygen vacancies.

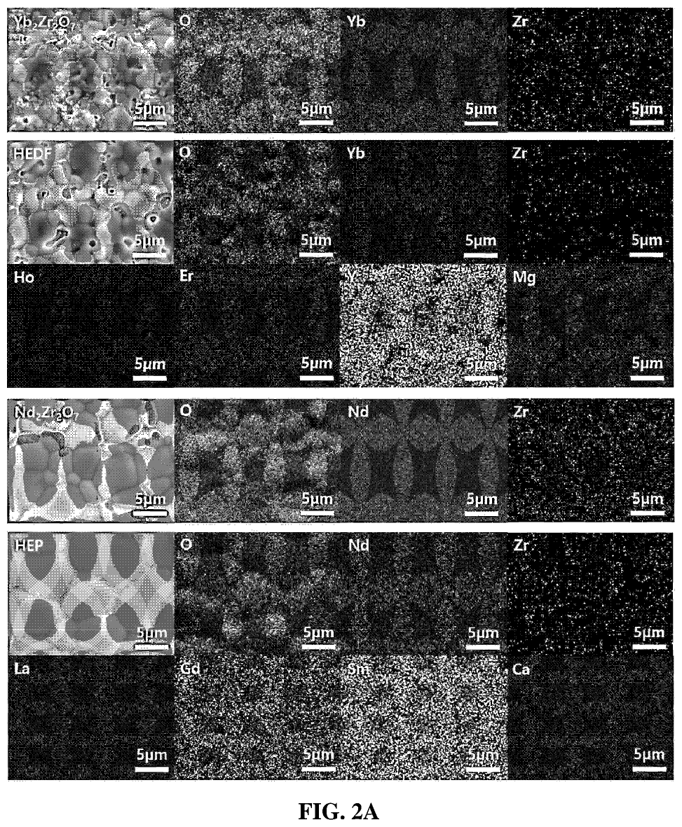

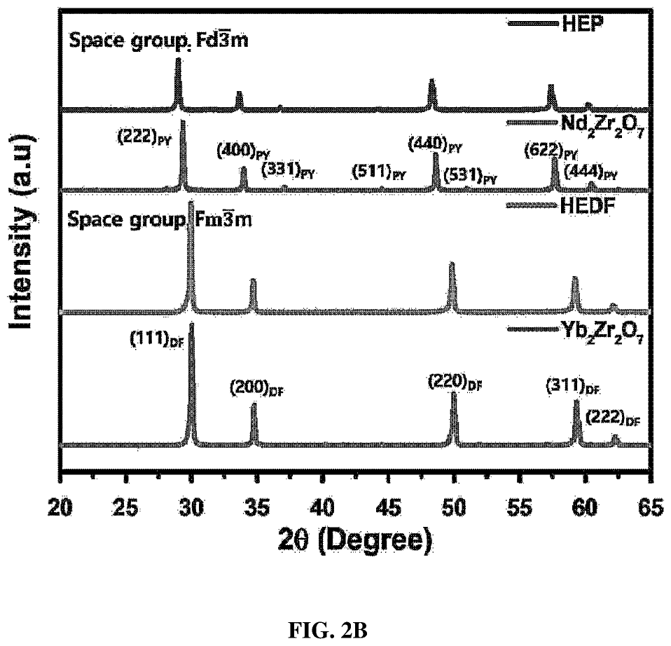

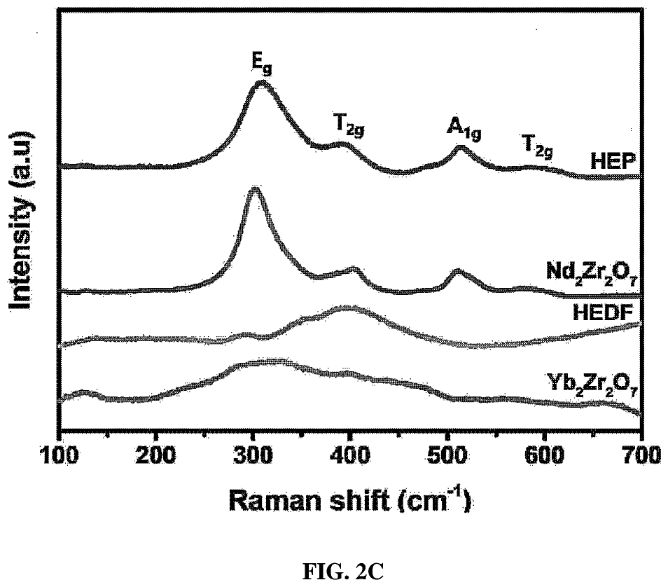

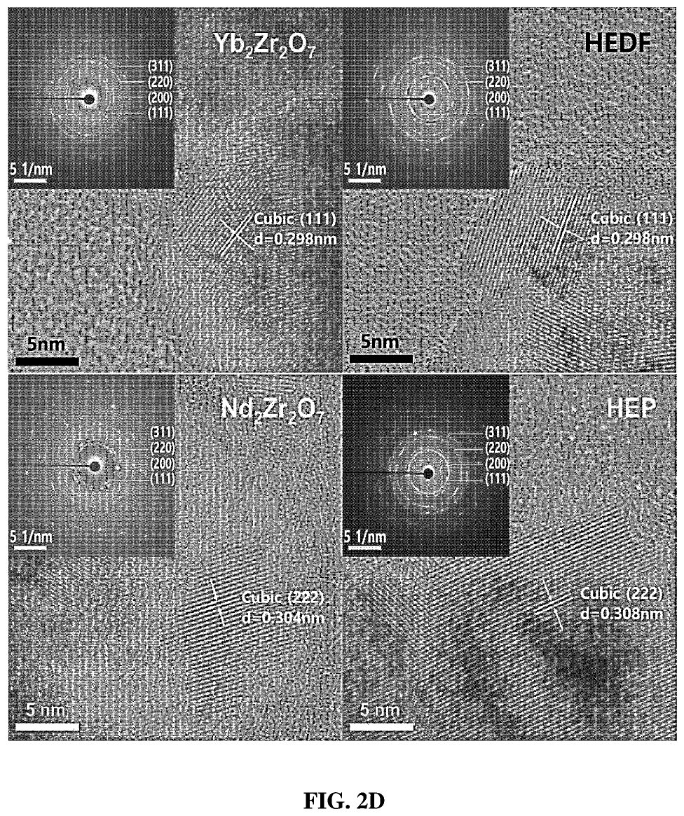

FIGS. 2A, 2B, 2C, and 2D show scanning electron microscopy (SEM) and energy dispersive spectroscopy (EDS) results (FIG. 2A), X-ray photoelectron spectroscopy (XPS) results (FIG. 2B), Raman spectroscopy results (FIG. 2C), and transmission electron microscopy (TEM) results (FIG. 2D) for conventional rare earth zirconates of Yb₂Zr₂O₇ and Nd₂Zr₂O₇ and high-entropy rare earth zirconates of HEDF (high-entropy defective fluorite) and HEP (high-entropy pyrochlore) according to an embodiment of the present invention.

Referring to FIGS. 2A, 2B, 2C, and 2D, the high-entropy rare earth zirconate of the present invention has a structure with increased oxygen vacancies, and it can be confirmed that it is formed as a single phase and is structurally stable compared to the conventional rare earth zirconate material (yttria stabilized zirconia (YSZ)).

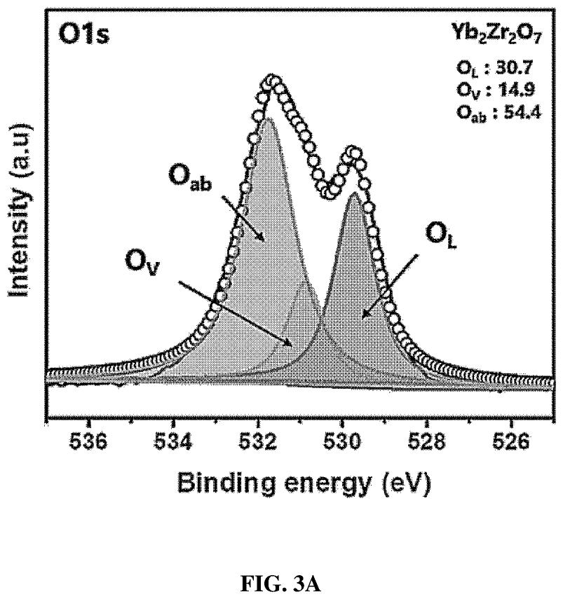

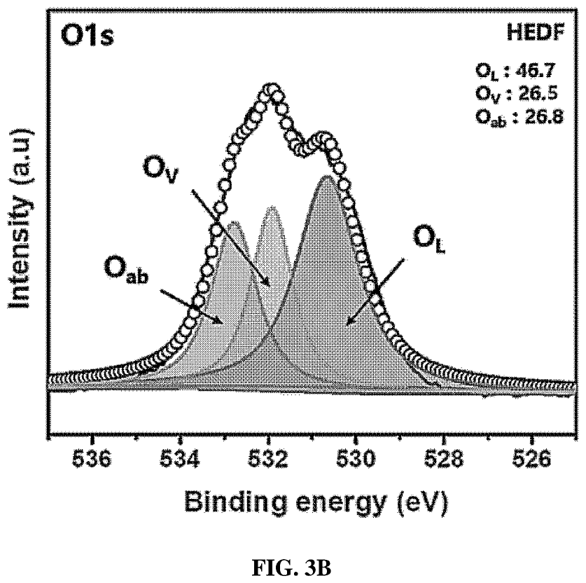

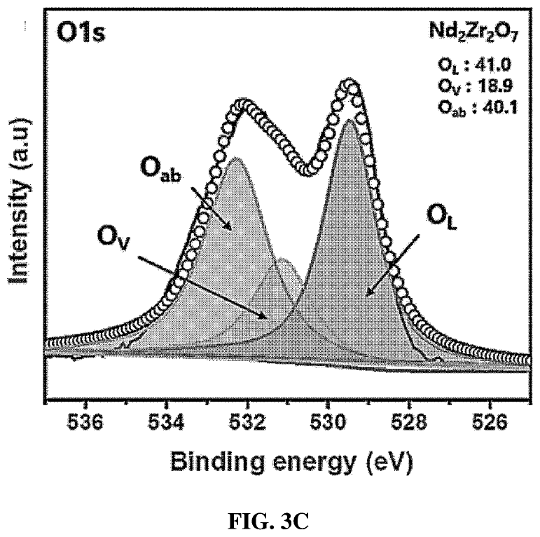

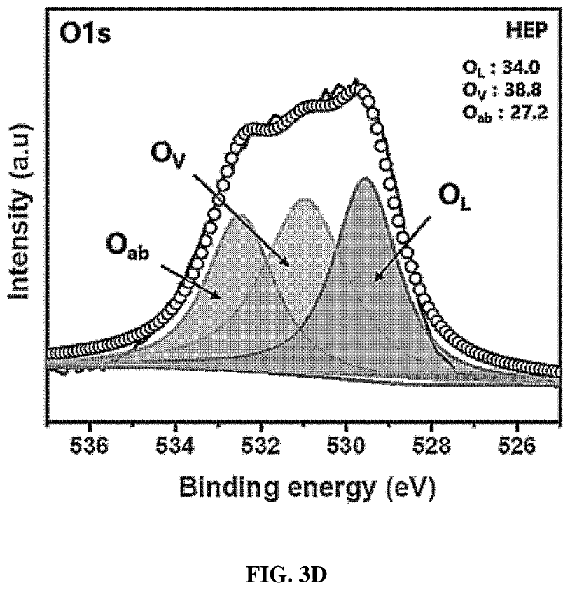

FIGS. 3A, 3B, 3C, and 3D are X-ray photoelectron spectroscopy (XPS) results of conventional rare earth zirconates and high-entropy rare earth zirconate according to an embodiment of the present invention.

Referring to FIGS. 3A, 3B, 3C, and 3D, it can be seen that the high-entropy rare earth zirconates of HEDF and HEP according to an embodiment of the present invention has a structure with increased oxygen vacancies compared to conventional rare earth zirconate materials (Yb₂Zr₂O₇ and Nd₂Zr₂O₇).

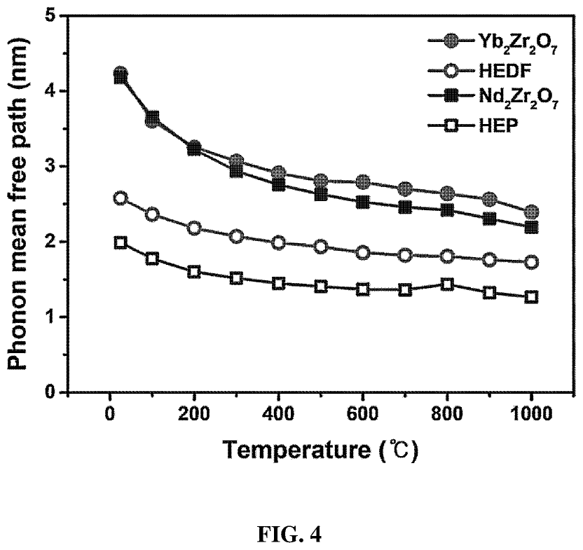

FIG. 4 is a graph showing the calculation results of the phonon mean free path of high-entropy rare earth zirconates according to an embodiment of the present invention compared to conventional rare earth zirconates.

Referring to FIG. 4, the high-entropy rare earth zirconate (HEDF, HEP) of the present invention has a structure with increased oxygen vacancies compared to conventional rare earth zirconate materials (Yb₂Zr₂O₇ and Nd₂Zr₂O₇), thereby reducing the phonon mean free path, and it was assumed that the heat transfer behavior of phonons was suppressed accordingly.

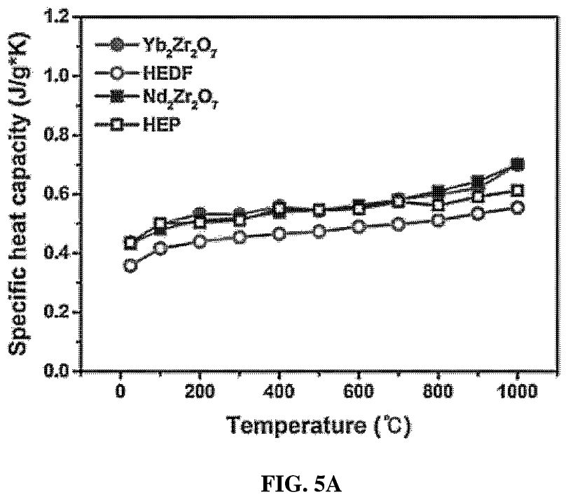

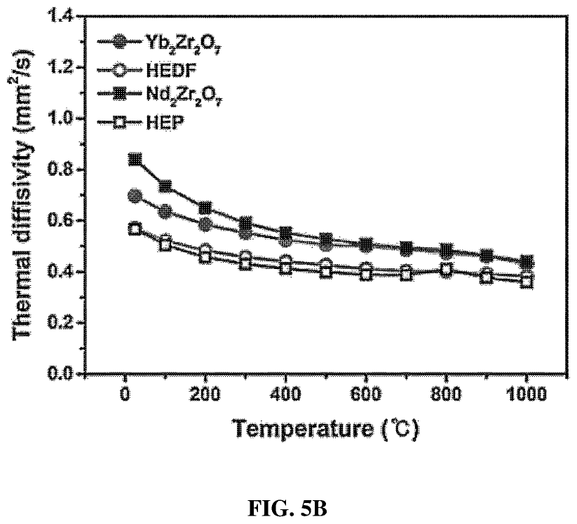

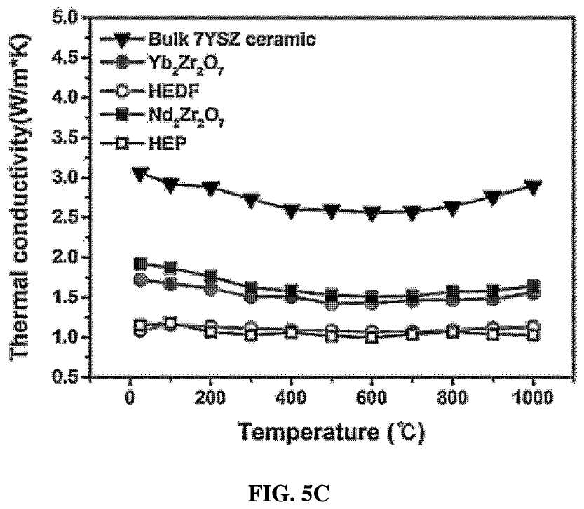

FIGS. 5A, 5B, and 5C are graphs showing specific heat capacity (FIG. 5A), thermal diffusivity (FIG. 5B), and thermal conductivity (FIG. 5C) of high-entropy rare earth zirconates according to embodiments of the present invention compared to conventional rare earth zirconates. Referring to FIGS. 5A, 5B, and 5C, it can be confirmed that the high-entropy rare earth zirconates (HEDF, HEP) of the present invention exhibit a low specific heat capacity, low thermal diffusivity, and low thermal conductivity compared to conventional rare earth zirconate materials (YSZ, Yb₂Zr₂O₇, and Nd₂Zr₂O₇). Heat conduction in general electrical insulating ceramics is mainly caused by phonon movement under a temperature gradient, and heat conduction by phonons can be determined by the phonon mean free path and average speed, which change depending on the number and position of atoms in the crystal structure. As the number of atoms per unit volume of the compound decreases and the atomic disorder increases, phonon scattering may occur and heat conduction may decrease. Compared to the conventional rare earth zirconate structure, it can be seen that the high-entropy rare earth zirconate of the present invention has fewer atoms per unit volume, creating oxygen vacancies at previously occupied atom sites, thereby increasing oxygen vacancies, and according to the calculation of the mean free path of phonons, it can be seen that the high-entropy material shows a reduced mean free path of phonons compared to the existing materials. In particular, as a result of thermal property analysis, it can be seen that the high-entropy material has lower thermal conductivity than the existing materials, which may due to the suppression of phonons' contribution to heat transfer. Therefore, the high-entropy rare earth zirconate material of the present invention has a low thermal conductivity of less than 1.5 W/m K, specifically a significantly low thermal conductivity of about 1 to 1.2 W/m K, in a high temperature environment ranging from room temperature to 1200° C., specifically room temperature to 1000° C.

As described above, the high-entropy rare earth zirconate material according to the present invention has improved thermophysical properties compared to existing materials and can be applied to the next-generation heat shield coating layer material. Specifically, it can be applied to oxidation-resistant coating systems and a thermal spray coating system that applies metal materials including materials that prevent oxidation of parts and materials to increase high-temperature stability to the surface of parts with the main purpose of preventing oxidation of high-temperature parts. In addition, the high-entropy rare earth zirconate according to the present invention can be used as a heat shielding material and as a coating for high-temperature parts such as aircraft and gas turbine engines.

While the exemplary embodiments of the present invention have been described above, those of ordinary skill in the art should understood that various changes, substitutions and alterations may be made herein without departing from the spirit and scope of the present invention as defined by the following claims.

1. High-entropy rare earth zirconate represented by the following Formula 1:
A₂Zr₂O₇ (1)
In Formula 1, A includes at least four types of trivalent cations and at least one type of divalent cation.

2. The high-entropy rare earth zirconate of claim 1, wherein 5 to 20 different ions are included in the A site.

3. The high-entropy rare earth zirconate of claim 1, wherein the ions included in the A site has the same stoichiometric ratio (equimolar ratio).

4. The high-entropy rare earth zirconate of claim 1, wherein the difference in ionic radii of the ions included in the A site is 1 to 20%.

5. The high-entropy rare earth zirconate of claim 1, wherein the trivalent cation is selected from transition metal ions or lanthanide ions, and the divalent cation is selected from alkaline earth metal ions.

6. The high-entropy rare earth zirconate of claim 5, wherein the trivalent cation is at least four types selected from Y³⁺, La³⁺, Nd³⁺, Sm³⁺, Gd³⁺, Ho³⁺, Er³⁺, Yb³⁺, and combinations thereof, and the divalent cation is at least one type selected from Be²⁺, Mg²⁺, Ca²⁺, Sr²⁺, Ba²⁺, Ra²⁺, and combinations thereof.

7. The high-entropy rare earth zirconate of claim 1, wherein the high-entropy rare earth zirconate has a defective fluorite structure or a pyrochlore structure.

8. The high-entropy rare earth zirconate of claim 1, wherein the high-entropy rare earth zirconate maintains a single phase in a high temperature environment ranging from room temperature to 1200°° C.
